(19) United States
(12) Patent Application Publication
(10) Pub. No.: US 2025/0355727 A1
(43) Pub. Date: Nov. 20, 2025

(54) INFORMATION PROCESSING SYSTEM, INFORMATION PROCESSING DEVICE, AND INFORMATION PROCESSING METHOD

(71) Applicant: Hitachi, Ltd., Tokyo (JP)

(72) Inventors: Rena IWAASA, Tokyo (JP); Nobuyuki YAMAMOTO, Tokyo (JP)

(21) Appl. No.: 19/204,771

(22) Filed: May 12, 2025

(30) Foreign Application Priority Data
May 15, 2024 (JP) 2024-079164

(51) Int. Cl. G06F 9/52; G06F 9/46

(52) U.S. Cl. CPC G06F 9/526; G06F 9/466

(57) ABSTRACT

Provided is a technique capable of executing optimal control in distributed transactions using a Saga pattern and lock early release. An information processing system of the present invention includes: a plurality of transaction managers that manages a respective plurality of transactions to be executed in a predetermined order for an external service unit; and a transaction controller that has functions of: calling the external service unit to execute the plurality of transactions in a predetermined order; executing a plurality of compensation transactions in order opposite to the predetermined order when an execution result of the plurality of transactions is failure; activating a lock function before calling the external service unit when each of the plurality of transactions is executed; and releasing the lock function after a transaction to be processed is executed and before an execution result of the transaction to be processed is output.

### CROSS-REFERENCE TO RELATED APPLICATION

The present application claims priority from Japanese application JP2024-079164, filed on May 15, 2024, the content of which is hereby incorporated by reference into this application.

### TECHNICAL FIELD

The present invention relates to an information processing system, an information processing device, and an information processing method.

### BACKGROUND ART

In recent years, microservices (microservice architecture) have attracted attention as a technique for constructing one large application or site by combining and linking a plurality of services small in scale. The microservices are each performed in which processing of one transaction (a series of indivisible processing) is performed in a distributed manner on a plurality of computers on a network, i.e., processing called distributed transaction is performed.

The distributed transaction is required to ensure consistency (result consistency) of update processing across a plurality of services, and the update processing is performed by a distributed agreement method called 2-phase commit, for example. The 2-phase commit is first performed in which a transaction manager managing the distributed transaction receives transmission of update execution results from all databases to be managed (referred to below as “prepared vote”). Then, the transaction manager determines a commit (success) or a rollback (failure) of a transaction based on the received prepared vote, and transmits the determination (settlement) result to each database side (referred to below as “settlement notification”). The database side having received the settlement notification performs processing according to the settlement result (commit or rollback).

When a plurality of services is executed in parallel to obtain one update result in the distributed transaction, the one update result is required to be ensured that it is the same result as in when the plurality of services is executed in series in a predetermined order (serializability). This rule is also referred to as commitment ordering. To observe this rule, preceding transaction processing (referred to below as “preceding transaction”) is first performed among a plurality of services to be executed in parallel. Then, after the settlement result (commit or rollback) is received in subsequent transaction processing (referred to below as “subsequent transaction”), the subsequent transaction is started. Each transaction processing is performed while resources are locked. Thus, each transaction processing is performed in which lock acquisition of a resource is performed at the start of the transaction processing, and lock release of the resource is performed at the end thereof. Then, during execution of the preceding transaction, the subsequent transaction is in a state of waiting for the lock acquisition of the resource.

Additionally, a method called lock early release has been conventionally proposed to shorten a lock period at the time of a commit settlement when a plurality of services is executed in parallel in the distributed transaction. The lock early release is configured to perform the lock release of the resource in the preceding transaction before the settlement notification (commit or rollback) is received from the transaction manager, specifically, before the prepared vote is executed. Unfortunately, when the preceding transaction has a settlement result of a rollback (failure), this method requires the subsequent transaction also to have its own settlement result of a rollback even when the subsequent transaction has its own settlement result of a commit (success). Hereinafter, this processing is referred to as “chain rollback”.

Conventional design patterns applicable to guarantee result consistency in microservice architecture include a design pattern called a Saga pattern. The Saga pattern has a concept as follows. When an error occurs in the middle of processing of a service while a series of processing of a plurality of services is performed, processing of canceling processing of each service performed prior to the service, i.e., a compensation transaction, is executed. At this time, the compensation transaction (rollback processing) of each service is executed in an order opposite to an execution order of the services before the error occurs.

Then, various techniques have been proposed in a conventional technical field of the distributed transaction described above to optimize processing, for example (e.g., see PTL 1). PTL 1 discloses a technique of guaranteeing serializability between distributed transactions by selecting a commit, an abort or a delay of a transaction to execute a commitment order in the same order as an execution order of a conflict operation of the transaction.

### CITATION LIST

### Patent Literature

PTL 1: U.S. Pat. No. 5,504,900

### SUMMARY OF INVENTION

### Technical Problem

Meanwhile, the microservices are also required to shorten a lock period while ensuring consistency in a distributed transaction when a plurality of services is executed in parallel. As a method for responding to the request, a method of using the lock early release described above for the distributed transaction to which the Saga pattern is applied is considered, and an optimal control method thereof is required. Although PTL 1 discloses the lock early release and the chain rollback, the Saga pattern (compensation transaction) is not studied.

The present invention has been made in view of the above circumstances, and an object of the present invention is to provide a technique capable of executing optimal control in a distributed transaction using the Saga pattern and the lock early release.

### Solution to Problem

To solve the above problem, an information processing system of the present invention includes a plurality of transaction managers and a transaction controller. The plurality of transaction managers manages a respective plurality of transactions to be executed in a predetermined order for an external service unit. The transaction controller is connected to the plurality of transaction managers and the external service unit. The transaction controller calls the external service unit to execute the plurality of transactions in a predetermined order. When an execution result of the plurality of transactions is failure, the transaction controller calls the external service unit to execute a plurality of compensation transactions for the respective plurality of transactions in order opposite to the predetermined order, the plurality of compensation transactions being for returning a state of the external service unit to a state before the plurality of transactions is executed. When executing each of the plurality of transactions, the transaction controller activates a lock function that disables execution of transactions other than the transaction to be processed among the plurality of transactions before calling the external service unit. The transaction controller also releases the lock function after the transaction to be processed is executed and before an execution result of the transaction to be processed is output to a transaction manager in the plurality of transaction managers, the transaction manager serving to manage the transaction to be processed.

To solve the above problem, an information processing device of the present invention includes the transaction controller provided in the information processing system of the present invention.

To solve the above problem, an information processing method of the present invention is performed by the information processing device of the present invention. The information processing method of the present invention is configured such that the transaction controller calls a service unit and executes a plurality of transactions in a predetermined order. When an execution result of the plurality of transactions is failure, the transaction controller calls the service unit to execute a plurality of compensation transactions for each of the plurality of transactions in order opposite to the predetermined order, the plurality of compensation transactions being for returning a state of the service unit to a state before the plurality of transactions is executed. When executing each of the plurality of transactions, the transaction controller activates a lock function that disables execution of transactions other than the transaction to be processed among the plurality of transactions before calling the service unit. The transaction controller also releases the lock function after the transaction to be processed is executed and before an execution result of the transaction to be processed is output to a transaction manager in the plurality of transaction managers, the transaction manager serving to manage the transaction to be processed.

### Advantageous Effects of Invention

The present invention having the above configuration enables optimal control to be executed in the distributed transaction using the Saga pattern and the lock early release.

### BRIEF DESCRIPTION OF DRAWINGS

FIG. 1 is a functional block configuration diagram of a distributed transaction control system according to an embodiment of the present invention.

FIG. 2 is a hardware configuration diagram of a distributed transaction control system according to an embodiment of the present invention.

FIG. 3 is a diagram illustrating a configuration example of service execution order information created by a service proxy of a distributed transaction control system according to an embodiment of the present invention.

FIG. 4 is a diagram illustrating a configuration example of service control information created by a service proxy of a distributed transaction control system according to an embodiment of the present invention.

FIG. 5 is a diagram for illustrating basic operation in distributed transaction control performed in a distributed transaction control system according to an embodiment of the present invention.

FIG. 6 is a diagram illustrating a control operation example at the time of successful update of a distributed transaction performed in a distributed transaction control system according to an embodiment of the present invention.

FIG. 7 is a diagram illustrating a control operation example at the time of failure update of a distributed transaction distributed performed in a transaction control system according to an embodiment of the present invention.

FIG. 8 is a flowchart illustrating a procedure of distributed transaction control processing performed by a service proxy of a distributed transaction control system according to an embodiment of the present invention.

FIG. 9 is a flowchart illustrating a procedure of distributed transaction management processing performed by a transaction manager of a distributed transaction control system according to an embodiment of the present invention.

FIG. 10 is a diagram illustrating a configuration example of a prepared vote waiting list created by a transaction manager of a distributed transaction control system according to an embodiment of the present invention.

FIG. 11 is a diagram illustrating a configuration example of a prepared vote waiting list created by a transaction manager of a distributed transaction control system according to an embodiment of the present invention.

### DESCRIPTION OF EMBODIMENTS

Hereinafter, a distributed transaction control system and a distributed transaction control method according to an embodiment of the present invention will be specifically described with reference to the drawings. The distributed transaction control system of the present embodiment is capable of executing a distributed transaction using a Saga pattern and lock early release.

### [Problem in Distributed Transaction Using Saga Pattern and Lock Early Release]

Before the distributed transaction control system and the distributed transaction control method according to the present embodiment are described, problems that can occur in a distributed transaction using the Saga pattern and the lock early release will be described.

The distributed transaction control system adopting the Saga pattern and the lock early release is required to guarantee result consistency in the distributed transaction even when a lock period of resource is shortened by the lock early release. Specifically, requirements (A) to (C) below need to be satisfied.
(A) During parallel execution of a plurality of transactions, serializability is achieved (following the Commitment Ordering rule).
(B) Data consistency at the time of a rollback (failure) is ensured (recoverability).
(C) Processing for the same resource (same service) is performed in which a compensation transaction is executed at the time of a rollback (failure) in the order opposite to the order at the time of data update.

The requirement (A) above is called isolation of distributed transactions, and the requirements (B) and (C) above are each called atomicity of distributed transactions.

However, there are problems below when resource update processing is performed in a service (application) connected to a transaction manager without a function (referred to below as a “parallelism control function”) that enables parallel execution of a plurality of transactions in the service, for example.
(a) In the service, a settlement or a non-settlement of a preceding transaction cannot be notified of a subsequent transaction.
(b) In the service, when the preceding transaction is a rollback (failure), information on the rollback cannot be notified of the subsequent transaction.
(c) In the service, an execution order of a compensation transaction cannot be controlled.

The problem (a) above may cause a state where global serializability is not achieved in which a processing order of prepared vote and commit notification in each transaction does not coincide with an execution order of the transactions for the service, for example. That is, the requirement (A) above may not be satisfied due to the problem (a) above. The problem (b) above may cause a state where the chain rollback cannot be performed in the subsequent transaction when the preceding transaction is a rollback (failure). The problem (c) above may cause a state where recovery possibility cannot be obtained. That is, the requirements (B) and (C) above may not be satisfied due to the problems (b) and (c) above.

To solve the various problems described above, the distributed transaction control system according to the present embodiment thus includes a service proxy (transaction controller) having a transaction parallelism control function, the service proxy being provided between the transaction manager (transaction manager) and the service (application). Then, the service proxy is configured to perform processing of notifying a settlement or a non-settlement of a preceding transaction of a subsequent transaction, processing of notifying settlement information when a preceding transaction is a rollback of a subsequent transaction, and processing of controlling an execution order of a compensation transaction.

### [Configuration of Distributed Transaction Control System]

### (Functional Block Configuration)

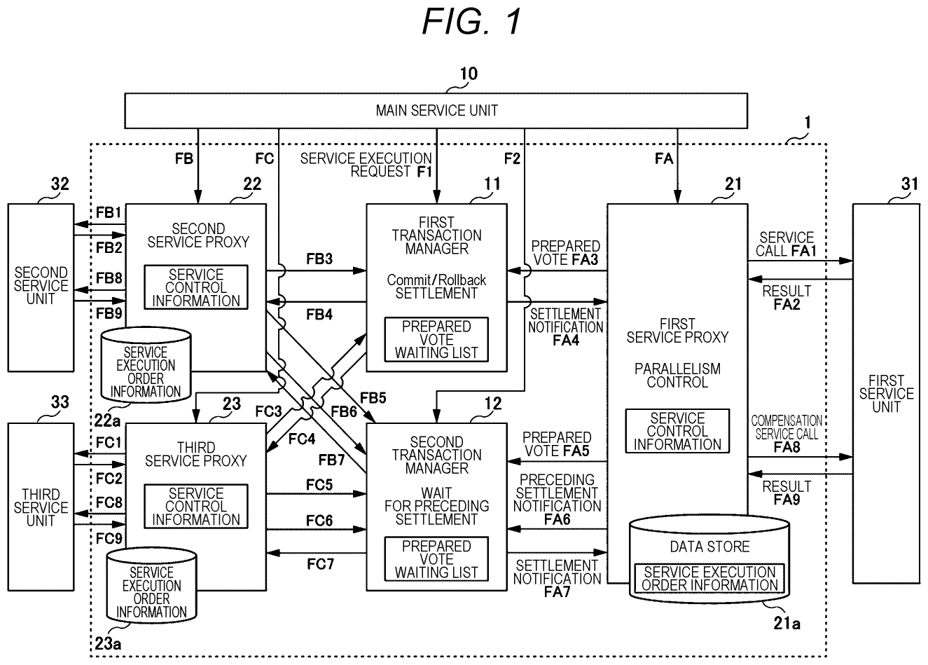

FIG. 1 is a functional block configuration diagram of the distributed transaction control system according to the present embodiment. The distributed transaction control system 1 (information processing system) functionally includes a first transaction manager 11, a second transaction manager 12, a first service proxy 21, a second service proxy 22, and a third service proxy 23. These functional units constituting the distributed transaction control system 1 are composed of software.

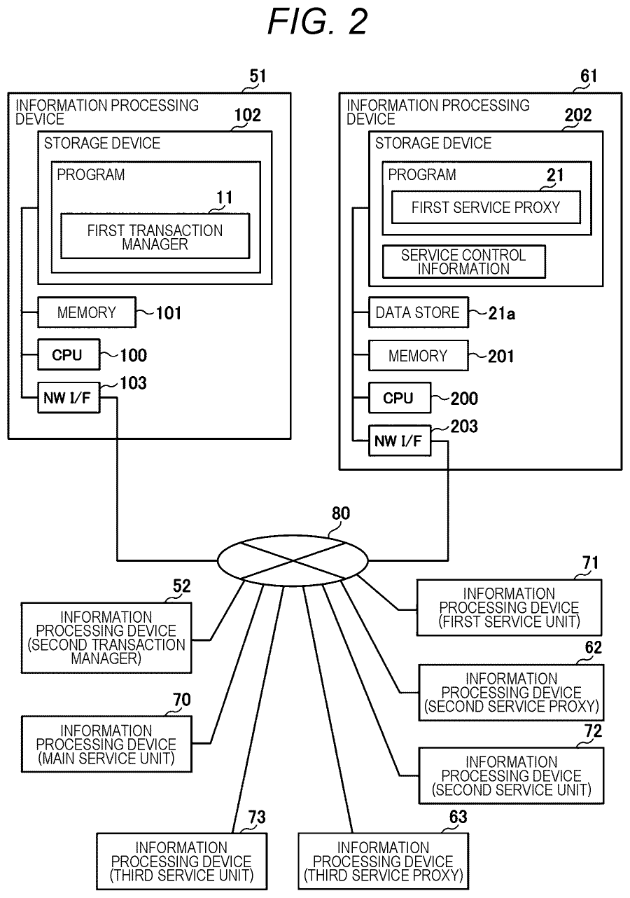

Although not illustrated in FIG. 1, the functional units constituting the distributed transaction control system 1 are connected to each other through an external network 80 (see FIG. 2 described later), and also the functional units and an external functional unit are connected therethrough.

Specifically, each of the first transaction manager 11, the second transaction manager 12, the first service proxy 21, the second service proxy 22, and the third service proxy 23 is connected to a main service unit 10 provided outside the distributed transaction control system 1 through the network 80. The main service unit 10 is a functional unit that receives an execution command of the distributed transaction operated by a user and transmits a service execution request corresponding to the execution command to each functional unit constituting the distributed transaction control system 1.

Each of the first transaction manager 11 and the second transaction manager 12 is connected to the first service proxy 21 through the network 80. The first service proxy 21 is also connected to a first service unit 31 provided outside the distributed transaction control system 1 through the network 80. That is, each of the first transaction manager 11 and the second transaction manager 12 is connected to the first service unit 31 through the first service proxy 21.

Each of the first transaction manager 11 and the second transaction manager 12 is also connected to the second service proxy 22 through the network 80. The second service proxy 22 is connected to a second service unit 32 provided outside the distributed transaction control system 1 through the network 80. That is, each of the first transaction manager 11 and the second transaction manager 12 is connected to the second service unit 32 through the second service proxy 22.

Each of the first transaction manager 11 and the second transaction manager 12 is further connected to the third service proxy 23 through the network 80. The third service proxy 23 is connected to a third service unit 33 provided outside the distributed transaction control system 1 through the network 80. That is, each of the first transaction manager 11 and the second transaction manager 12 is connected to the third service unit 33 through the third service proxy 23.

Each of the first service unit 31, the second service unit 32, and the third service unit 33 is a functional unit that performs predetermined application processing (including data update processing) in the distributed transaction.

As described above, the distributed transaction control system 1 according to the present embodiment has a configuration (load distribution configuration) in which a service proxy is provided for each service unit (resource). Then, each service proxy calls a corresponding service unit to perform transaction processing in the present embodiment. Although the present embodiment illustrates an example in which the number of service units is three and the number of service proxies provided corresponding to the respective service units is also three, the present invention is not limited thereto. For example, the number of service units (service proxies) may be two or the number of service units (service proxies) may be four or more according to an application or the like of the distributed transaction control system 1.

As described above, the present embodiment has a configuration in which the transaction manager is provided for each transaction (load distribution configuration). The present embodiment illustrates an example in which the first transaction manager 11 manages a preceding transaction T1 (predetermined transaction) and the second transaction manager 12 manages a subsequent transaction T2 (specific transaction). The example is then described in which control (management) is performed to cause the preceding transaction T1 and the subsequent transaction T2 executed in parallel to have a result identical to that of the preceding transaction T1 and the subsequent transaction T2 executed in series in this order.

### (Hardware Configuration)

FIG. 2 is a hardware configuration diagram of the distributed transaction control system 1 according to the present embodiment. In the present embodiment, each functional unit constituting the distributed transaction control system 1 is provided in a separate information processing device. Each of the main service unit 10, the first service unit 31, the second service unit 32, and the third service unit 33 provided outside the distributed transaction control system 1 is also provided in a separate information processing device.

Specifically, an information processing device 51 including the first transaction manager 11, and an information processing device 52 including the second transaction manager 12, are provided separately from each other as illustrated in FIG. 2. Then, an information processing device 61 including the first service proxy 21, an information processing device 62 including the second service proxy 22, and an information processing device 63 including the third service proxy 23, are provided separately from each other. Additionally, an information processing device 70 including the main service unit 10, an information processing device 71 including the first service unit 31, an information processing device 72 including the second service unit 32, and an information processing device 73 including the third service unit 33, are provided separately from each other. These information processing devices are then connected to each other through the network 80.

The information processing device 51 including the first transaction manager 11 is composed of a computer device or the like having a calculation function and a communication function, and includes a central processing unit (CPU) 100, a memory 101, a storage device 102, and a network interface (NW I/F) 103 as illustrated in FIG. 2.

The CPU 100 reads out a program code of software from the memory 101 to the storage device 102, the program code enabling processing of the first transaction manager 11, and executes the program code. At this time, variables, parameters, and the like generated during arithmetic processing are also temporarily written in the storage device 102.

The storage device 102 includes a random access memory (RAM), and the storage device 102 stores various data required for the arithmetic processing performed by the CPU 100. The memory 101 includes a read only memory (ROM), and the memory 101 stores various kinds of software for executing arithmetic processing using the CPU 100.

The network interface 103 includes a network interface card (NIC) or the like, for example, and transmits and receives various data to and from each device connected through wireless communication. Thus, the information processing device 51 is connected to the network 80 through the network interface 103.

The information processing device 52 including the second transaction manager 12 has a configuration similar to that of the information processing device 51 including the first transaction manager 11. However, the information processing device 52 causes its CPU to read out a program code of software from its memory to its storage device, the program code enabling processing of the second transaction manager 12, and executes the program code.

The information processing device 61 including the first service proxy 21 includes a computer device or the like having a calculation function and a communication function, and includes a CPU 200, a memory 201, a storage device 202, a network interface (NW I/F) 203, and a data store 21a (storage unit) as illustrated in FIG. 2.

The CPU 200 reads out a program code of software from the memory 201 to the storage device 202, the program code enabling processing of the first service proxy 21, and executes the program code. At this time, variables, parameters, and the like generated during arithmetic processing are also temporarily written in the storage device 202.

The storage device 202 includes a RAM, and the storage device 202 stores various data required for the arithmetic processing performed by the CPU 200. For example, the storage device 202 stores service control information (see FIG. 4 described later) to be referred to in processing in the first service proxy 21. The memory 201 includes a ROM, and the memory 201 stores various kinds of software for executing arithmetic processing using the CPU 200.

The network interface 203 includes a NIC or the like, for example, and transmits and receives various data to and from each device connected through wireless communication. Thus, the information processing device 61 is connected to the network 80 through the network interface 203.

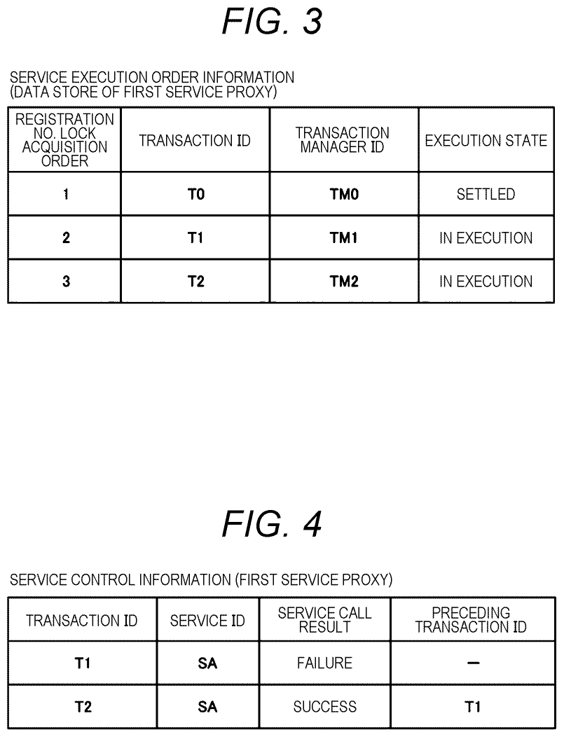

The data store 21a can be composed of a storage device capable of rewriting data, for example, a nonvolatile storage. The data store 21a stores service execution order information described later (see FIG. 3 described later) to be updated (written) and referred to (read) by the first service proxy 21, for example.

The information processing device 62 including the second service proxy 22 has a configuration similar to that of the information processing device 61 including the first service proxy 21. However, the information processing device 62 causes its CPU to read out a program code of software from its memory to its storage device, the program code enabling processing of the second service proxy 22, and executes the program code. The information processing device 62 is also provided with a data store 22a (see FIG. 1), for example, the data store 22a being configured to store the service execution order information described later (see FIG. 3 described later) to be updated (written) and referred to (read) by the second service proxy 22.

The information processing device 63 including the third service proxy 23 has a configuration that is also similar to that of the information processing device 61 including the first service proxy 21. However, the information processing device 63 causes its CPU to read out a program code of software from its memory to its storage device, the program code enabling processing of the third service proxy 23, and executes the program code. The information processing device 63 is also provided with a data store 23a (see FIG. 1), for example, the data store 23a being configured to store the service execution order information described later (see FIG. 3 described later) to be updated (written) and referred to (read) by the third service proxy 23.

Each of the information processing device 70 including the main service unit 10, the information processing device 71 including the first service unit 31, the information processing device 72 including the second service unit 32, and the information processing device 73 including the third service unit 33 is also composed of a computer device or the like having a calculation function and a communication function. Although not illustrated, each of the information processing device 70 to the information processing device 73 includes a CPU, a memory, a storage device, a network interface, and a data store. Then, each information processing device causes its CPU to read out a program code of software from its memory to its storage device, the program code enabling processing of a corresponding service (application), and executes the program code.

### [Outline of Operation of Each Functional Unit of Distributed Transaction Control System]

Next, an outline of operation of each functional unit of the distributed transaction control system 1 will be described with reference to FIG. 1.

### (First Transaction Manager)

As illustrated in FIG. 1, the first transaction manager 11 that manages processing of the preceding transaction T1 starts management processing of the preceding transaction T1 when receiving a service execution request F1 from the main service unit 10 through the network 80.

The first transaction manager 11 receives (obtains) prepared vote FA3 (update execution result in the first service unit 31) of the preceding transaction T1 from the first service proxy 21 through the network 80. The first transaction manager 11 receives prepared vote FB3 (update execution result in the second service unit 32) of the preceding transaction T1 from the second service proxy 22 through the network 80. The first transaction manager 11 also receives prepared vote FC3 (update execution result in the second service unit 32) of the preceding transaction T1 from the third service proxy 23 through the network 80.

When receiving prepared vote from all the service proxies (service units) to be managed, the first transaction manager 11 determines a commit (success) or a rollback (failure) of the preceding transaction T1 based on the prepared vote. Then, the first transaction manager 11 transmits (outputs) settlement notifications FA4, FB4, and FC4 indicating determination results of the preceding transaction T1 to the first service proxy 21, the second service proxy 22, and the third service proxy 23, respectively, through the network 80.

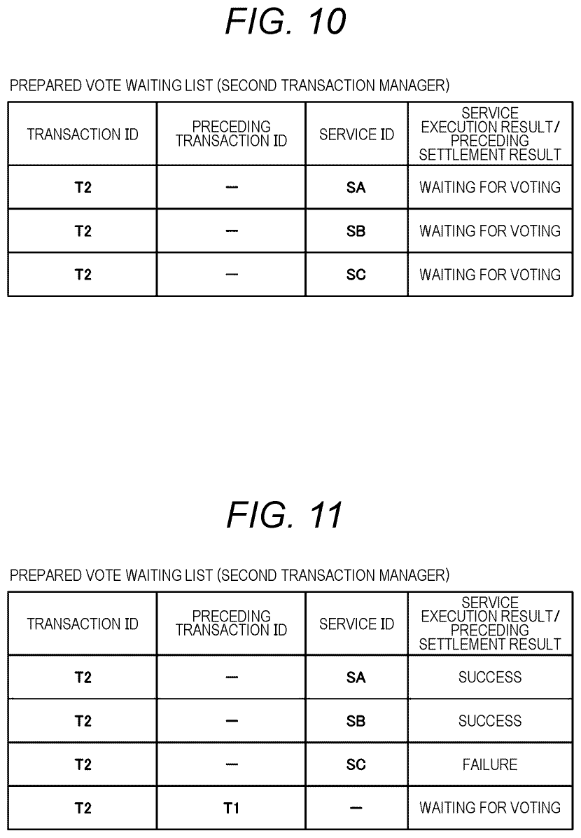

In the present embodiment, the storage device 102 in the information processing device 51 including the first transaction manager 11 stores a prepared vote waiting list that defines information such as whether each prepared vote is received and a settlement notification for each prepared vote. Then, the first transaction manager 11 updates the prepared vote waiting list in a series of processing from reception of the prepared vote from each service proxy to transmission of the settlement notification. A configuration of the prepared vote waiting list and an update mode of the prepared vote waiting list will be described in detail later (FIGS. 10 and 11 described later).

### (Second Transaction Manager)

As illustrated in FIG. 1, the second transaction manager 12 that manages processing of the subsequent transaction T2 starts management processing of the subsequent transaction T2 when receiving a service execution request F2 from the main service unit 10 through the network 80.

The second transaction manager 12 receives (obtains) prepared vote FA5 (update execution result in the first service unit 31) of the subsequent transaction T2 from the first service proxy 21 through the network 80. When the preceding transaction T1 has not been settled at this time, settlement waiting instruction information (specific information) on the preceding transaction T1 is added to the prepared vote FA5 that is from the first service proxy 21. In this case, the second transaction manager 12 thus performs processing of waiting for a settlement notification (a commit or a rollback) of the preceding transaction T1 based on the settlement waiting instruction information on the preceding transaction T1 added to the prepared vote FA5.

When the settlement waiting instruction information on the preceding transaction T1 is added to the prepared vote FA5, the second transaction manager 12 receives information (referred to below as “preceding settlement notification”) FA6 on settlement contents of the preceding transaction T1 from the first service proxy 21 through the network 80 after receiving the prepared vote FA5.

The second transaction manager 12 receives prepared vote FB5 (update execution result in the second service unit 32) from the second service proxy 22 through the network 80. When the preceding transaction T1 has not been settled at this time, settlement waiting instruction information on the preceding transaction T1 is added to the prepared vote FB5 that is from the second service proxy 22. In this case, the second transaction manager 12 thus performs processing of waiting for a settlement notification (a commit or a rollback) of the preceding transaction T1 based on the settlement waiting instruction information on the preceding transaction T1 added to the prepared vote FB5.

When the settlement waiting instruction information on the preceding transaction T1 is added to the prepared vote FB5, the second transaction manager 12 receives preceding settlement notification FB6 of the preceding transaction T1 from the second service proxy 22 through the network 80 after receiving the prepared vote FB5.

The second transaction manager 12 receives prepared vote FC5 (update execution result in the third service unit 33) from the third service proxy 23 through the network 80. When the preceding transaction T1 has not been settled at this time, settlement waiting instruction information on the preceding transaction T1 is added to the prepared vote FC5 that is from the third service proxy 23. In this case, the second transaction manager 12 thus performs processing of waiting for a settlement notification (a commit or a rollback) of the preceding transaction T1 based on the settlement waiting instruction information on the preceding transaction T1 added to the prepared vote FC5.

When the settlement waiting instruction information on the preceding transaction T1 is added to the prepared vote FC5, the second transaction manager 12 receives preceding settlement notification FC6 of the preceding transaction T1 from the third service proxy 23 through the network 80 after receiving the prepared vote FC5.

Then, after receiving the prepared vote and the preceding settlement notification from all the service proxies to be managed, the second transaction manager 12 determines a commit (success) or a rollback (failure) of the subsequent transaction T2 based on the notifications. After that, the second transaction manager 12 transmits (outputs) settlement notifications FA7, FB7, and FC7 indicating determination results to the first service proxy 21, the second service proxy 22, and the third service proxy 23, respectively, through the network 80.

However, when the contents of the preceding settlement notification of the preceding transaction T1 received from the service proxy is a rollback (failure) at this time, the second transaction manager 12 transmits a settlement notification indicating the rollback (failure) of the subsequent transaction T2 to the service proxy regardless of an actual settlement result (a commit or a rollback) of the subsequent transaction T2. Consequently, the chain rollback is implemented.

### (First Service Proxy)

The first service proxy 21 calls the first service unit 31 and performs corresponding application processing (data update processing) in the distributed transaction. The first service proxy 21 has a parallelism control function of a transaction and can perform lock control for each transaction.

In the present embodiment, the preceding transaction T1 and the subsequent transaction T2 for the first service unit 31 are executed in parallel in the first service proxy 21. Specifically, the first service proxy 21 executes a series of processing of: acquiring (activating) a lock (lock function); calling the first service unit 31; executing a transaction for the first service unit 31; obtaining an execution result; and releasing the lock, in each transaction. Although a transaction to be processed can be executed when the lock (lock function) is activated, other transactions cannot be executed. Thus, the subsequent transaction T2 is in an execution waiting state during a lock period for executing the preceding transaction T1.

When the distributed transaction has a settlement result of a rollback (failure), the first service proxy 21 calls the first service unit 31 to perform a compensation transaction (processing of returning to an original state). At this time, the first service proxy 21 refers to the service execution order information described later (see FIG. 3 described later) to perform the compensation transaction in an order opposite to the execution order of the transaction (predetermined order). Specifically, the first service proxy 21 first calls the first service unit 31 to perform the compensation transaction for the subsequent transaction T2, and then performs the compensation transaction for the preceding transaction T1. In each compensation transaction, a series of processing is performed, the processing including: acquiring a lock; calling the first service unit 31; executing a compensation transaction on the first service unit 31; obtaining an execution result; and releasing the lock.

An outline of a flow of processing operation performed by the first service proxy 21 is as follows. As illustrated in FIG. 1, when receiving a service execution request FA from the main service unit 10 through the network 80, the first service proxy 21 acquires a lock of the preceding transaction T1 and starts executing the preceding transaction T1 for the first service unit 31. In the present embodiment, information (referred to below as “service execution order information”) indicating an execution order of transactions to be executed by the first service proxy 21 is stored in the data store 21a of the information processing device 61 (see FIG. 2) including the first service proxy 21. Then, when acquiring the lock of the preceding transaction T1, the first service proxy 21 accesses the data store 21a to store information on the preceding transaction T1 in the service execution order information (see FIG. 3 described later).

When the preceding transaction T1 for the first service unit 31 is executed and the lock is released, the first service proxy 21 transmits (outputs) the prepared vote FA3 corresponding to an execution result (success or failure) of the preceding transaction T1 for the first service unit 31 to the first transaction manager 11 through the network 80. At this time, the first service proxy 21 stores information on the execution result (success or failure) of the preceding transaction T1 for the first service unit 31 in the service control information described later (see FIG. 4 described later) stored in the storage device 202 of the information processing device 61 including the first service proxy 21. Then, after releasing the lock of the preceding transaction T1, the first service proxy 21 receives (obtains) the settlement notification FA4 (commit or rollback) of the preceding transaction T1 from the first transaction manager 11 through the network 80.

When the lock of the preceding transaction T1 is released, the first service proxy 21 acquires a lock of the subsequent transaction T2 and starts executing the subsequent transaction T2 for the first service unit 31. When the first service proxy 21 acquires the subsequent transaction T2, the first service proxy 21 accesses the data store 21a to store information on the subsequent transaction T2 in the service execution order information.

When the subsequent transaction T2 is executed and the lock is released after the lock of the subsequent transaction T2 for the first service unit 31 is obtained, the first service proxy 21 transmits (outputs) the prepared vote FA5 corresponding to an execution result (success or failure) of the subsequent transaction T2 for the first service unit 31 to the first transaction manager 11 through the network 80. When the settlement notification FA4 of the preceding transaction T1 has not been received at this time, the first service proxy 21 transmits the prepared vote FA5, to which the settlement waiting instruction information on the preceding transaction T1 has been added, to the first transaction manager 11. At this time, the first service proxy 21 stores information on the execution result (success or failure) of the subsequent transaction T2 in the service control information stored in the storage device 202.

When the settlement notification FA4 on the preceding transaction T1 is not received at the time of transmission of the prepared vote FA5, the first service proxy 21 transmits (outputs) the preceding settlement notification FA6 (information on the determination result) to the second transaction manager 12 through the network 80 after receiving the settlement notification FA4 of the preceding transaction T1. After that, the first service proxy 21 receives (obtains) the settlement notification FA7 (commit or rollback) of the subsequent transaction T2 from the first transaction manager 11 through the network 80.

Then, when the subsequent transaction T2 (distributed transaction) has a settlement result (settlement notification FA7) of a commit (success), the first service proxy 21 deletes the service control information stored in the storage device 202 of the information processing device 61 including the first service proxy 21 and the service execution order information stored in the data store 21a.

In contrast, when the subsequent transaction T2 (distributed transaction) has a settlement result (settlement notification FA7) of a rollback (failure), the first service proxy 21 calls the first service unit 31 to perform the corresponding compensation transaction (processing of returning to the original state). Specifically, the first service proxy 21 performs the compensation transaction in an execution order opposite to the execution order of the transaction with reference to the service execution order information (see FIG. 3 described later) stored in the data store 21a, and then deletes the service control information and the service execution order information.

### (Second Service Proxy)

The second service proxy 22 calls the second service unit 32 to perform corresponding application processing (data update processing) in the transaction processing. The second service proxy 22 has a parallelism control function of a transaction and can perform lock control for each transaction. Thus, the preceding transaction T1 and the subsequent transaction T2 for the second service unit 32 are executed in parallel in the second service proxy 22 in the present embodiment. Specifically, the second service proxy 22 executes a series of processing of: acquiring a lock; calling the second service unit 32; executing a transaction for the second service unit 32; obtaining an execution result; and releasing the lock, in each transaction.

When the distributed transaction has a settlement result of a rollback (failure), the second service proxy 22 calls the second service unit 32 to perform a compensation transaction (processing of returning to the original state). At this time, the second service proxy 22 refers to the service execution order information to perform the compensation transaction in an order opposite to the execution order of the transaction. Specifically, the second service proxy 22 first calls the second service unit 32 to perform the compensation transaction for the subsequent transaction T2, and then performs the compensation transaction for the preceding transaction T1. In each compensation transaction, a series of processing is performed, the processing including: acquiring a lock; calling the second service unit 32; executing a compensation transaction on the second service unit 32; obtaining an execution result; and releasing the lock.

As illustrated in FIG. 1, when receiving a service execution request FB from the main service unit 10 through the network 80, the second service proxy 22 acquires the lock of the preceding transaction T1 and starts executing the preceding transaction T1 for the second service unit 32. Subsequent processing operation of the second service proxy 22 for the first transaction manager 11 and the second transaction manager 12 is performed as with the processing operation of the first service proxy 21. Thus, the description thereof is not described here.

### (Third Service Proxy)

The third service proxy 23 calls the third service unit 33 to perform corresponding application processing (data update processing) in the transaction processing. The third service proxy 23 has a parallelism control function of a transaction and can perform lock control for each transaction. Thus, the preceding transaction T1 and the subsequent transaction T2 for the third service unit 33 are executed in parallel in the third service proxy 23 in the present embodiment. Specifically, the third service proxy 23 executes a series of processing of: acquiring a lock; calling the third service unit 33; executing a transaction for the third service unit 33; obtaining an execution result; and releasing the lock, in each transaction.

When the distributed transaction has a settlement result of a rollback (failure), the third service proxy 23 calls the third service unit 33 to perform a compensation transaction (processing of returning to the original state). At this time, the third service proxy 23 refers to the service execution order information to perform the compensation transaction in an order opposite to the execution order of the transaction. Specifically, the third service proxy 23 first calls the third service unit 33 to perform the compensation transaction for the subsequent transaction T2, and then performs the compensation transaction for the preceding transaction T1. In each compensation transaction, a series of processing is performed, the processing including: acquiring a lock; calling the third service unit 33; executing a compensation transaction on the third service unit 33; obtaining an execution result; and releasing the lock.

As illustrated in FIG. 1, when receiving a service execution request FC from the main service unit 10 through the network 80, the third service proxy 23 acquires the lock of the preceding transaction T1 and starts executing the preceding transaction T1 for the third service unit 33. Subsequent processing operation of the third service proxy 23 for the first transaction manager 11 and the second transaction manager 12 is performed as with the processing operation of the first service proxy 21. Thus, the description thereof is not described here.

### [Configuration of Service Execution Order Information]

Next, a configuration of the service execution order information (predetermined information) stored in a data store of an information processing device having a corresponding service proxy will be described. FIG. 3 is a diagram illustrating a configuration of the service execution order information stored in the data store 21a of the information processing device 61 including the first service proxy 21. The configuration of the service execution order information stored in each of the data store 22a of the second service proxy 22 and the data store 23a of the third service proxy 23 is also similar to the configuration illustrated in FIG. 3. Thus, only the configuration of the service execution order information stored in the data store 21a of the first service proxy 21 will be described here.

The service execution order information is data in a table form. The service execution order information includes a transaction ID, a transaction manager ID, and a transaction execution state that are defined in association with each other for each of registration numbers (“1” to “3”) indicating lock acquisition orders as illustrated in FIG. 3. The registration numbers of the lock acquisition orders indicate lock acquisitions in order, and the number of “1” is set as a registration number of the earliest lock acquisition. Thus, a data set with the registration number “1” arranged at the top in the service execution order information in an example illustrated in FIG. 3 shows a transaction in which the lock is first acquired.

The transaction ID is identification information on a transaction. Transaction IDs “T1” and “T2” in FIG. 3 are identification information on the preceding transaction T1 and that on the subsequent transaction T2, respectively. Although detailed description is not described, a transaction ID “TO” in FIG. 3 is identification information on a transaction executed for the first service unit 31 by a transaction manager (not illustrated) different from the first transaction manager 11 and the second transaction manager 12 before the preceding transaction T1.

The transaction manager ID is identification information on a transaction manager that manages a transaction. Transaction manager IDs “TM1” and “TM2” in FIG. 3 are identification information on the first transaction manager 11 that manages the preceding transaction T1 and that on the second transaction manager 12 that manages the subsequent transaction T2, respectively. A transaction manager ID “TM0” in FIG. 3 is identification information on another transaction manager (not illustrated) that manages the transaction ID “TO”.

The transaction execution state is information indicating that a registered transaction is in execution or settled. When a service proxy acquires a lock of a transaction, information indicating “in execution” is set in the transaction execution state. When a service proxy receives a settlement notification of a commit (success), information indicating “settled” is set as the transaction execution state at the time of receiving the settlement notification. In contrast, when a service proxy receives a settlement notification of a rollback (failure), information indicating the “settled” is set as the transaction execution state after each compensation transaction is executed.

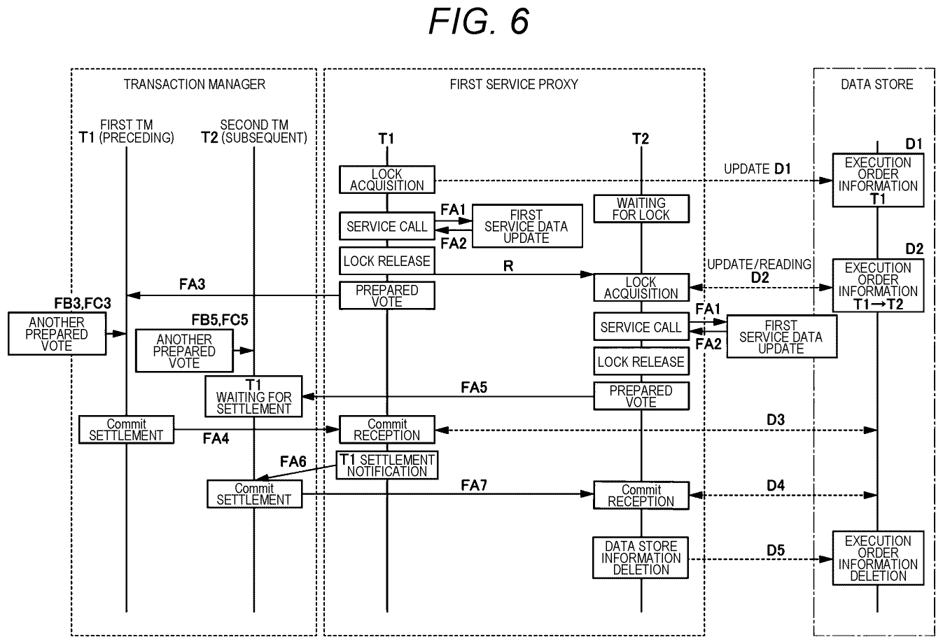

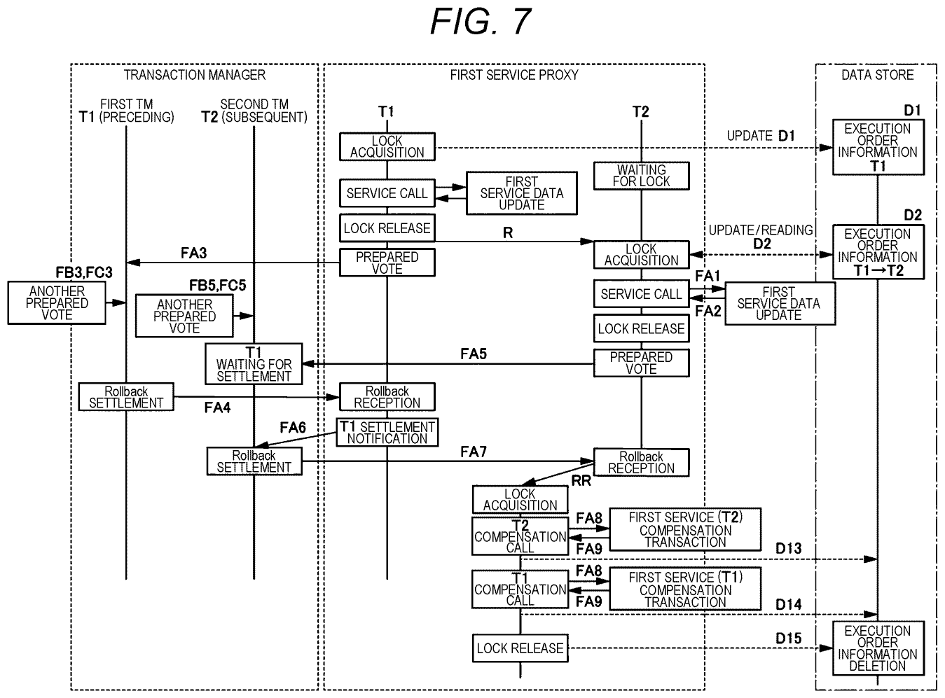

As described later, the service execution order information is updated at predetermined timing during the distributed transaction control processing by a service proxy (see FIGS. 6 and 7 described later) in the present embodiment. Thus, when the service proxy (the distributed transaction control system 1) stops for some reason during the distributed transaction control processing by the service proxy, the service execution order information at that time may be left without being cleared. In this case, the execution order of the transaction can be confirmed with reference to the service execution order information at the time of restart, so that a data update state of the service unit can be reliably returned to the original state, and thus fault tolerance can be improved.

### [Configuration of Service Control Information]

Next, a configuration of the service control information stored in a storage device of an information processing device having a corresponding service proxy will be described. FIG. 4 is a diagram illustrating a configuration of the service control information stored in the storage device 202 of the information processing device 61 including the first service proxy 21. A configuration of the service control information stored in a storage device (not illustrated) of each of the second service proxy 22 and the third service proxy 23 is also similar to the configuration illustrated in FIG. 4. Thus, only the configuration of the service control information stored in the storage device 202 of the first service proxy 21 will be described here.

The service control information is data in a table form. As illustrated in FIG. 4, a service ID, a service call result, and a preceding transaction ID are defined in association with each other for each transaction ID in the service control information. The service control information is updated each time the service proxy obtains an execution result of a transaction from the corresponding service unit.

The service ID is identification information on a service unit controlled by a service proxy, and a service ID “SA” in FIG. 4 is identification information on the first service unit 31 controlled by the first service proxy 21. In the present embodiment, a service ID of the second service unit 32 controlled by the second service proxy 22 is “SB”, and a service ID of the third service unit 33 controlled by the third service proxy 23 is “SC”.

The service call result is an execution result (success or failure) obtained when the first service proxy 21 calls the first service unit 31 to perform application processing (data update processing) after a lock is acquired. Information on the service call result is included in prepared vote transmitted from the first service proxy 21 to the first transaction manager 11 and the second transaction manager 12. Thus, the prepared vote FA3 including information on “failure” as an execution result of the preceding transaction T1 for the first service unit 31 is transmitted from the first service proxy 21 to the first transaction manager 11 in an example illustrated in FIG. 4. The example illustrated in FIG. 4 also shows that the prepared vote FA5 including information on “success” as an execution result of the subsequent transaction T2 for the first service unit 31 is transmitted from the first service proxy 21 to the second transaction manager 12.

The preceding transaction ID is identification information on a transaction executed prior to its own transaction. Thus, the example illustrated in FIG. 4 defines no information in a preceding transaction ID field in the service control information because no preceding transaction exists for the preceding transaction T1. In contrast, the preceding transaction T1 exists for the subsequent transaction T2, so that identification information (T1) on the preceding transaction T1 is set in the preceding transaction ID field in the service control information.

### [Example of Control Operation of Distributed Transaction Control System]

Next, examples of various kinds of control operation of distributed transactions performed in the distributed transaction control system 1 of the present embodiment will be described. However, an example of control operation of transaction processing for the first service unit 31 will be described below to simplify description. Transaction processing for each of the second service unit 32 and the third service unit 33 is performed similarly to the transaction processing for the first service unit 31 described below.

### (Basic Control Operation)

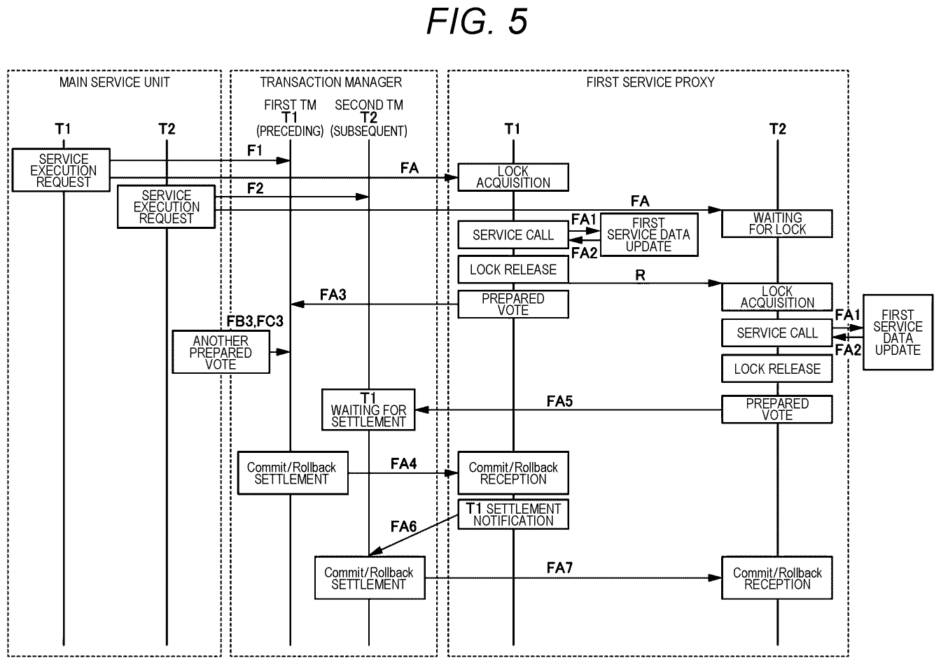

First, an example of basic control operation of a distributed transaction performed on the first service unit 31 in the distributed transaction control system 1 will be described. FIG. 5 is a diagram illustrating a basic operation flow in distributed transaction control performed on the first service unit 31 in the distributed transaction control system 1.

When execution command operation of the transaction processing is performed by the user, the main service unit 10 first transmits the service execution requests F1, F2 and FA to the first transaction manager 11 (a first TM in the drawing), the second transaction manager 12 (a second TM in the drawing), and the first service proxy 21, respectively, as illustrated in FIG. 5. Consequently, management control of the preceding transaction T1 using the first transaction manager 11 and management control of the subsequent transaction T2 using the second transaction manager 12 are started.

The first service proxy 21 having received the service execution request FA performs lock acquisition processing of the preceding transaction T1. At this time, the first service proxy 21 starts lock waiting processing for the subsequent transaction T2.

After acquiring the lock of the preceding transaction T1, the first service proxy 21 calls the first service unit 31 (arrow FA1 in the drawing) in the preceding transaction T1 to perform the application processing (data update) of the first service unit 31. Then, the first service proxy 21 obtains an execution result of the preceding transaction T1 for the first service unit 31 (arrow FA2 in the drawing). Next, the first service proxy 21 releases the lock of the preceding transaction T1. That is, the lock release (lock early release) of the preceding transaction T1 is performed before the settlement notification FA4 of the preceding transaction T1 is received. After that, the first service proxy 21 transmits the prepared vote FA3 of the preceding transaction T1 for the first service unit 31 to the first transaction manager 11.

When the lock of the preceding transaction T1 is released, the first service proxy 21 performs the lock acquisition processing of the subsequent transaction T2 in the subsequent transaction T2 (arrow R in the drawing). After that, the first service proxy 21 calls the first service unit 31 (arrow FA1 in the drawing) to perform the application processing (data update) of the first service unit 31 in the subsequent transaction T2. Then, the first service proxy 21 obtains an execution result of the subsequent transaction T2 for the first service unit 31 (arrow FA2 in the drawing). Next, the first service proxy 21 releases the lock of the subsequent transaction T2. After that, the first service proxy 21 transmits the prepared vote FA5 of the subsequent transaction T2 for the first service unit 31 to the second transaction manager 12.

At this time, when the first service proxy 21 has not received the settlement notification FA4 of the preceding transaction T1 from the first transaction manager 11 at the time of transmitting the prepared vote FA5, the first service proxy 21 transmits the prepared vote FA5, to which the settlement waiting instruction information on the preceding transaction T1 is added, to the second transaction manager 12 as in an example illustrated in FIG. 5. When the first service proxy 21 has received the settlement notification FA4 of the preceding transaction T from the first transaction manager 11 at the time of transmission of the prepared vote FA5, the settlement waiting instruction information on the preceding transaction T1 is not added to the prepared vote FA5.

The second transaction manager 12 having received the prepared vote FA5 of the subsequent transaction T2 performs settlement waiting processing of the preceding transaction T1 based on the settlement waiting instruction information on the preceding transaction T1 added to the prepared vote FA5. After that, the second transaction manager 12 waits until receiving the preceding settlement notification FA6 of the preceding transaction T1 from the first service proxy 21.

The example illustrated in FIG. 5 shows that after the second transaction manager 12 receives the prepared vote FA5 of the subsequent transaction T2, the first transaction manager 11 determines a settlement result (commit (success) or rollback (failure)) of the preceding transaction T1. Then, the first transaction manager 11 transmits the corresponding settlement notification FA4 to the first service proxy 21.

Although detailed description is not described, the example illustrated in FIG. 5 is configured to cause not only the second service proxy 22 to transmit the prepared vote FB3 of the preceding transaction T1 for the second service unit 32 to the first transaction manager 11, but also the third service proxy 23 to transmit the prepared vote FC3 of the preceding transaction T1 for the third service unit 33 to the first transaction manager 11, before the first transaction manager 11 determines the settlement result of the preceding transaction T1. Thus, the first transaction manager 11 determines the settlement result (commit (success) or rollback (failure)) of the preceding transaction T1 based on contents of a prepared vote of the preceding transaction T1 received from each service proxy in determination processing of the settlement result of the preceding transaction T1 described above.

Then, the first service proxy 21 having received the settlement notification FA4 of the preceding transaction T1 transmits the preceding settlement notification FA6 to the second transaction manager 12 in the preceding transaction T1.

The second transaction manager 12 having received the preceding settlement notification FA6 from the first service proxy 21 cancels a settlement waiting state of the preceding transaction T1. Then, the second transaction manager 12 determines a settlement result (commit (success) or rollback (failure)) of the subsequent transaction T2. Subsequently, the second transaction manager 12 transmits the corresponding settlement notification FA7 to the first service proxy 21.

Although illustration and detailed description are not described, the example illustrated in FIG. 5 is configured to cause not only the second service proxy 22 to transmit the prepared vote FB5 of the subsequent transaction T2 for the second service unit 32 to the second transaction manager 12, but also the third service proxy 23 to transmit the prepared vote FC5 of the subsequent transaction T2 for the third service unit 33 to the second transaction manager 12 (see FIGS. 6 and 7 described later), before the second transaction manager 12 determines the determination result of the subsequent transaction T2. Although illustration and detailed description are not described, the example illustrated in FIG. 5 is also configured to cause the second service proxy 22 and the third service proxy 23 to transmit the preceding settlement notifications FB6 and FC6, respectively, to the second transaction manager 12 before the second transaction manager 12 determines the settlement result of the subsequent transaction T2.

Thus, the second transaction manager 12 determines the settlement result (commit (success) or rollback (failure)) of the subsequent transaction T2 based on contents of a prepared vote and a preceding settlement notification of the subsequent transaction T2 received from each service proxy in the determination processing of the settlement result of the subsequent transaction T2 described above. However, when the received preceding settlement notification FA6 has contents of a rollback at this time, the second transaction manager 12 also sets the settlement result of the subsequent transaction T2 as a rollback (chain rollback).

Then, the first service proxy 21 having received the settlement notification FA7 of the subsequent transaction T2 performs processing corresponding to the settlement notification FA7 in the subsequent transaction T2.

Specifically, when the settlement notification FA7 of the subsequent transaction T2 is a commit (success), the first service proxy 21 deletes the service control information and the service execution order information to end the distributed transaction for the first service unit 31. In contrast, when the settlement notification FA7 of the subsequent transaction T2 is a rollback (failure), the first service proxy 21 calls the first service unit 31 to execute the compensation transaction, and then deletes the service control information and the service execution order information to end the distributed transaction for the first service unit 31.

(Example of Control Operation when Distributed Transaction is Success)

Next, an example of control operation will be described in which the distributed transaction performed in the distributed transaction control system 1 has a settlement result of success (commit). FIG. 6 is a diagram illustrating a control operation flow when the distributed transaction is success in the distributed transaction control system 1.

To simplify description, FIG. 6 illustrates a flow of processing operation after the first service proxy 21 acquires the lock of the preceding transaction T1. Here, a flow of update processing of the service execution order information will also be described, the update processing being performed in the middle of execution of the distributed transaction for the first service unit 31.

When receiving the service execution request FA, the first service proxy 21 first performs the lock acquisition processing of the preceding transaction T1 for the first service unit 31. At this time, the first service proxy 21 accesses the data store 21a of the information processing device 61 including the first service proxy 21 to update the service execution order information (see FIG. 3) (arrow D1 in the drawing). Specifically, the first service proxy 21 sets a registration number in order of execution of the preceding transaction T1 in the service execution order information, the preceding transaction T1 having acquired the lock this time. The first service proxy 21 also stores an ID “T1” of the preceding transaction T1, an ID “TM1” of a transaction manager in charge, and the “in execution” of an execution state of the preceding transaction T1 in association with the registration number having been set.

When the lock of the preceding transaction T1 is acquired, the first service proxy 21 starts the lock waiting processing for the subsequent transaction T2.

After acquiring the lock of the preceding transaction T1, the first service proxy 21 calls the first service unit 31 (arrow FA1 in the drawing) in the preceding transaction T1 to perform the application processing (data update) of the first service unit 31. Then, the first service proxy 21 obtains an execution result of the preceding transaction T1 for the first service unit 31 (arrow FA2 in the drawing). Next, the first service proxy 21 releases the lock of the preceding transaction T1. That is, the lock release (lock early release) of the preceding transaction T1 is performed before the settlement notification FA4 of the preceding transaction T1 is received. After that, the first service proxy 21 transmits the prepared vote FA3 of the preceding transaction T1 for the first service unit 31 to the first transaction manager 11.

When the lock of the preceding transaction T1 is released, the first service proxy 21 performs the lock acquisition processing of the subsequent transaction T2 in the subsequent transaction T2 (arrow R in the drawing). At this time, the first service proxy 21 accesses the data store 21a to update the service execution order information (see FIG. 3) (arrow D2 in the drawing). Specifically, the first service proxy 21 sets a registration number (=the registration number of the preceding transaction T1+1) in order of execution of the subsequent transaction T2 in the service execution order information, the subsequent transaction T2 having acquired the lock this time. The first service proxy 21 also stores an ID “T2” of the subsequent transaction T2, an ID “TM2” of a transaction manager in charge, and the “in execution” of an execution state of the subsequent transaction T2 in association with the registration number having been set.

After that, the first service proxy 21 calls the first service unit 31 (arrow FA1 in the drawing) to perform the application processing (data update) of the first service unit 31 in the subsequent transaction T2. Then, the first service proxy 21 obtains an execution result of the subsequent transaction T2 for the first service unit 31 (arrow FA2 in the drawing). Next, the first service proxy 21 releases the lock of the subsequent transaction T2. After that, the first service proxy 21 transmits the prepared vote FA5 of the subsequent transaction T2 for the first service unit 31 to the second transaction manager 12. FIG. 6 shows an example in which the first service proxy 21 has not received the settlement notification FA4 of the preceding transaction T1 from the first transaction manager 11 at the time of transmitting the prepared vote FA5, so that the first service proxy 21 transmits the prepared vote FA5, to which the settlement waiting instruction information on the preceding transaction T1 is added, to the second transaction manager 12.

The second transaction manager 12 having received the prepared vote FA5 of the subsequent transaction T2 performs settlement waiting processing of the preceding transaction T1 based on the settlement waiting instruction information on the preceding transaction T1 added to the prepared vote FA5. After that, the second transaction manager 12 waits until receiving the preceding settlement notification FA6 of the preceding transaction T1 from the first service proxy 21.

The example illustrated in FIG. 6 shows that after the second transaction manager 12 receives the prepared vote FA5 of the subsequent transaction T2, the first transaction manager 11 determines a settlement result (commit (success) or rollback (failure)) of the preceding transaction T1 for the first service unit 31. Then, the first transaction manager 11 transmits the corresponding settlement notification FA4 to the first service proxy 21. The example illustrated in FIG. 6 shows that the settlement result of the preceding transaction T1 is a commit (success), so that the first transaction manager 11 transmits a settlement notification FA4 of the commit (success) to the first service proxy 21.

Although detailed description is not described, the example illustrated in FIG. 6 is configured to cause not only the second service proxy 22 to transmit the prepared vote FB3 of the preceding transaction T1 for the second service unit 32 to the first transaction manager 11, but also the third service proxy 23 to transmit the prepared vote FC3 of the preceding transaction T1 for the third service unit 33 to the first transaction manager 11, before the first transaction manager 11 determines the settlement result of the preceding transaction T1. Thus, the first transaction manager 11 determines the settlement result (commit) of the preceding transaction T1 based on contents of a prepared vote of the preceding transaction T1 received from each service proxy in the determination processing of the settlement result of the preceding transaction T1 described above.

The first service proxy 21 having received the settlement notification FA4 (commit) of the preceding transaction T1 accesses the data store 21a to update the service execution order information (see FIG. 3) in the preceding transaction T1 (arrow D3 in the drawing). Specifically, the first service proxy 21 changes the execution state of the preceding transaction T1 associated with the registration number of the preceding transaction T1 from the “in execution” to “settled” in the service execution order information.

Then, the first service proxy 21 having received the settlement notification FA4 (commit) of the preceding transaction T1 transmits the preceding settlement notification FA6 (commit) to the second transaction manager 12 in the preceding transaction T1.

The second transaction manager 12 having received the preceding settlement notification FA6 from the first service proxy 21 cancels a settlement waiting state of the preceding transaction T1. Then, the second transaction manager 12 determines a settlement result (commit (success) or rollback (failure)) of the subsequent transaction T2. Subsequently, the second transaction manager 12 transmits the corresponding settlement notification FA7 to the first service proxy 21. The example illustrated in FIG. 6 shows that the settlement result of the subsequent transaction T2 is a commit (success), so that the second transaction manager 12 transmits the settlement notification FA7 of the commit (success) to the first service proxy 21.

Although detailed description is not described, the example illustrated in FIG. 6 is configured to cause not only the second service proxy 22 to transmit the prepared vote FB5 of the subsequent transaction T2 for the second service unit 32 to the second transaction manager 12, but also the third service proxy 23 to transmit the prepared vote FC5 of the subsequent transaction T2 for the third service unit 33 to the second transaction manager 12, before the second transaction manager 12 determines the settlement result of the subsequent transaction T2. Although illustration and detailed description are not described, the example illustrated in FIG. 6 is also configured to cause the second service proxy 22 and the third service proxy 23 to transmit the preceding settlement notifications FB6 and FC6, respectively, to the second transaction manager 12 before the second transaction manager 12 determines the settlement result of the subsequent transaction T2.

Thus, the second transaction manager 12 determines the settlement result (commit) of the subsequent transaction T2 based on contents of a prepared vote and a preceding settlement notification of the subsequent transaction T2 received from each service proxy in the determination processing of the settlement result of the subsequent transaction T2 described above.

The first service proxy 21 having received the settlement notification FA7 (commit) of the subsequent transaction T2 accesses the data store 21a to update the service execution order information (see FIG. 3) in the subsequent transaction T2 (arrow D4 in the drawing). Specifically, the first service proxy 21 changes the execution state of the subsequent transaction T2 associated with the registration number of the subsequent transaction T2 from the “in execution” to “settled” in the service execution order information.

After that, the first service proxy 21 accesses the data store 21a to delete the service execution order information (see FIG. 3) (arrow D5 in the drawing). Although not illustrated, the first service proxy 21 also deletes the service control information (see FIG. 4), which is stored in the storage device 202 of the information processing device 61 including the first service proxy 21, at this timing.

Then, distributed transaction processing on the first service unit 31 ends by processing described above of deleting the service execution order information and the service control information in the example illustrated in FIG. 6.

(Example of Control Operation when Distributed Transaction Fails)

Next, an example of control operation will be described in which the distributed transaction performed in the distributed transaction control system 1 has a settlement result of failure (rollback). Here, the example of control operation will be described in which the preceding transaction T1 has a settlement result of a rollback (failure).

FIG. 7 is a diagram illustrating a control operation flow when the distributed transaction fails in the distributed transaction control system 1. To simplify description, FIG. 7 illustrates a flow of processing operation after the first service proxy 21 acquires the lock of the preceding transaction T1. Here, a flow of update processing of the service execution order information will also be described, the update processing being performed in the middle of execution of the distributed transaction for the first service unit 31.

As is evident from a comparison between FIG. 7 and FIG. 6, the control operation flow illustrated in FIG. 7 includes a flow up to the settlement waiting processing of the preceding transaction T1 in the second transaction manager 12 when the distributed transaction fails, the flow being the same as that illustrated in FIG. 6 when the distributed transaction is success. Thus, the description of the control operation flow up to the settlement waiting processing of the preceding transaction T1 in the second transaction manager 12 is not described, and the control operation flow after that will be described.

FIG. 7 shows an example in which after the settlement waiting processing of the preceding transaction T1 is started in the second transaction manager 12 having received the prepared vote FA5 of the subsequent transaction T2, the first transaction manager 11 determines a settlement result (commit (success) or rollback (failure)) of the preceding transaction T1. Then, the first transaction manager 11 transmits the corresponding settlement notification FA4 to the first service proxy 21. However, the preceding transaction T1 for the first service unit 31 has a settlement result of a rollback (failure) in the example illustrated in FIG. 7, so that the first transaction manager 11 transmits information on the rollback to the first service proxy 21 as the settlement notification FA4 of the preceding transaction T1.

The first service proxy 21 having received the settlement notification FA4 (rollback) of the preceding transaction T1 transmits the preceding settlement notification FA6 (rollback) to the second transaction manager 12 in the preceding transaction T1.

The second transaction manager 12 having received the preceding settlement notification FA6 from the first service proxy 21 cancels a settlement waiting state of the preceding transaction T1. Then, the second transaction manager 12 determines a settlement result (commit (success) or rollback (failure)) of the subsequent transaction T2. However, the preceding transaction T1 has a settlement result of a rollback (failure) in the example illustrated in FIG. 7, so that the second transaction manager 12 sets a settlement result of a rollback for the subsequent transaction T2 regardless of an execution result (prepared vote FA5) of the subsequent transaction T2. That is, the second transaction manager 12 executes the chain rollback.

Then, the second transaction manager 12 transmits the settlement notification FA7 corresponding to the rollback (failure) to the first service proxy 21.

The first service proxy 21 having received the settlement notification FA7 of the rollback of the subsequent transaction T2 performs the lock acquisition processing to execute the compensation transaction (arrow RR in the drawing). The lock acquisition processing activates a transaction different from the preceding transaction T1 and the subsequent transaction T2 in the example illustrated in FIG. 7 to execute the compensation transaction described later for the first service unit 31 in the different transaction. The present invention is not limited thereto, and the compensation transaction described later for the first service unit 31 may be configured to be executed in the subsequent transaction T2, for example.

After a lock of the compensation transaction is obtained, the first service proxy 21 refers to the service execution order information (see FIG. 3) stored in the data store 21a to perform the compensation transaction according to the Saga pattern. Specifically, the first service proxy 21 first calls the first service unit 31 (arrow FA8 in the drawing) to execute the compensation transaction for the subsequent transaction T2. This processing returns a state of the first service unit 31 to a state before execution of the subsequent transaction T2. Then, the first service proxy 21 obtains an execution result of the compensation transaction for the subsequent transaction T2 from the first service unit 31 (arrow FA9 in the drawing).

After executing the compensation transaction for the subsequent transaction T2, the first service proxy 21 accesses the data store 21a to update the service execution order information (see FIG. 3) (arrow D13 in the drawing). Specifically, the first service proxy 21 changes the execution state of the subsequent transaction T2 associated with the registration number of the subsequent transaction T2 from the “in execution” to “settled” in the service execution order information.

After that, the first service proxy 21 calls the first service unit 31 (arrow FA8 in the drawing) to execute the compensation transaction for the preceding transaction T1. This processing returns the state of the first service unit 31 to a state before execution of the preceding transaction T1. Then, the first service proxy 21 obtains an execution result of the compensation transaction for the preceding transaction T1 from the first service unit 31 (arrow FA9 in the drawing).

After executing the compensation transaction for the preceding transaction T1, the first service proxy 21 accesses the data store 21a to update the service execution order information (see FIG. 3) (arrow D14 in the drawing). Specifically, the first service proxy 21 changes the execution state of the preceding transaction T1 associated with the registration number of the preceding transaction T1 from the “in execution” to “settled” in the service execution order information.

After that, the first service proxy 21 performs lock release of the compensation transaction. At this time, the first service proxy 21 accesses the data store 21a to delete the service execution order information (see FIG. 3) (arrow D15 in the drawing). Although not illustrated, the first service proxy 21 also deletes the service control information (see FIG. 4), which is stored in the storage device 202 of the information processing device 61 including the first service proxy 21, at this timing.

Then, distributed transaction processing on the first service unit 31 ends by the lock release of the compensation transaction and the processing of deleting the service execution order information and the service control information, which are described above, in the example illustrated in FIG. 7.

### [Processing Flow in Distributed Transaction Control System]

Next, specific processing contents of a distributed transaction will be described with reference to the drawings, the distributed transaction being executed by the distributed transaction control system 1 when the various examples of control operation of the distributed transaction control system 1 described above are executed.

### (Distributed Transaction Control Processing Performed by Service Proxy)

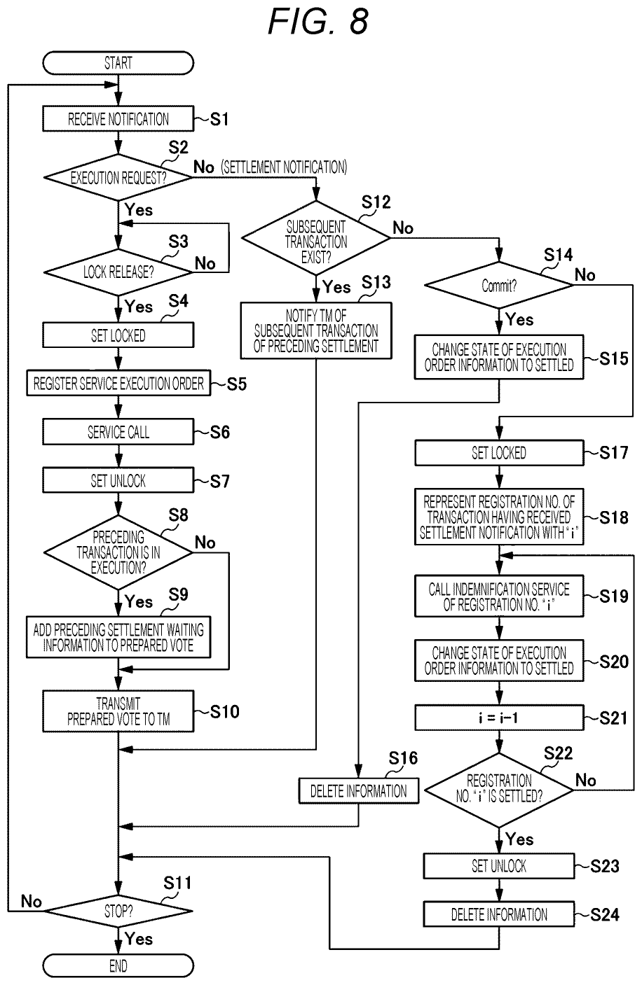

FIG. 8 is a flowchart illustrating a procedure of distributed transaction control processing (information processing method) performed by a service proxy when the distributed transaction control system 1 executes the distributed transaction. The distributed transaction control processing illustrated in FIG. 8 is executed in parallel in each of the first service proxy 21, the second service proxy 22, and the third service proxy 23.

The distributed transaction control processing in the service proxy illustrated in FIG. 8 is executed on software by a CPU of an information processing device (see FIG. 2) including the service proxy. For example, the distributed transaction control processing below using the first service proxy 21 is executed on software by the CPU 200 (see FIG. 2) of the information processing device 61 including the first service proxy 21.

First, the service proxy (CPU) performs processing of receiving notification from the outside (S1). Specifically, the service proxy performs reception processing of a service execution request from the main service unit 10 or reception processing of a settlement notification from a transaction manager through the network 80. At timing without these notifications, the service proxy waits until notification is received in the processing in S1.

Then, the service proxy determines whether the received notification is a service execution request (S2). When the service proxy determines that the received notification is not a service execution request (determination in S2 is No) in S2, the service proxy performs processing in S12 described later.

In contrast, when the service proxy determines that the received notification is a service execution request in S2 (determination in S2 is Yes), the service proxy determines whether “unlock” is set in a lock flag (S3).

The lock flag indicates whether a period is a lock period in which a transaction or a compensation transaction is executed, and is stored in a storage device (RAM) of the information processing device (see FIG. 2) including the service proxy. The lock flag is set with information on any one of “locked” (1) and “unlock” (0). Specifically, the lock flag is set with the “locked” in a period from lock acquisition to lock release (during execution of a transaction or a compensation transaction) in control of the service proxy. The lock flag is set with the “unlock” in another period (timing), such as a period in which lock is released and after the period, or a lock waiting period of the subsequent transaction T2, for example.

When the service proxy determines in S3 that the “unlock” is not set to the lock flag (the “locked” is set) (determination in S3 is No), the service proxy repeats the processing in S3. In contrast, when the service proxy determines that the “unlock” is set to the lock flag in S3 (determination in S3 is Yes), the service proxy sets the “locked” to the lock flag (S4). This processing obtains a lock of a transaction to be processed.

Next, the service proxy performs registration (update) processing of the service execution order information (S5). This processing is performed in which the service proxy accesses a data store (See FIGS. 1 and 2) of the information processing device including the service proxy to update the service execution order information (see FIG. 3). Specifically, the service proxy sets a registration number of the transaction in order of execution, the transaction having acquired the lock this time, in the service execution order information, and stores the registration number in association with a transaction ID, a corresponding transaction manager ID, and an execution state (in execution) of the transaction.

Next, the service proxy calls a corresponding service unit, and executes the application processing (data update) of the corresponding service unit to obtain an execution result (S6). Subsequently, the service proxy sets the “unlock” in the lock flag (S7). This processing releases the lock of the transaction to be processed.

Then, the service proxy determines whether the preceding transaction T1 is in execution (S8). This processing has a determination result of Yes only when a transaction being processed is the subsequent transaction T2 and the preceding transaction T1 is in execution, and otherwise has a determination result of No. At this time, it is determined whether the preceding transaction T1 is in execution with reference to the service execution order information (see FIG. 3), and when the “in execution” is set as an execution state of the preceding transaction T1 in the service execution order information, it is determined that the preceding transaction T1 is in execution.

When the service proxy determines that the preceding transaction T1 is not in execution in S8 (determination in S8 is No), the service proxy performs processing in S10 described later.

In contrast, when the service proxy determines that the preceding transaction T1 is in execution in S8 (determination in S8 is Yes), the service proxy adds the settlement waiting instruction information on the preceding transaction T1 to the prepared vote (FA5 in FIG. 1) (S9).

After processing in S9 ends or when determination is No in S8, the service proxy transmits a prepared vote to a transaction manager (TM) in charge of management of a transaction, which is currently processed, through the network 80 (S10). The prepared vote transmitted in this processing is set with information corresponding to an execution result (success/failure) of the application processing (data update) of the service unit, the execution result being obtained in the processing in S6. When the processing in S10 is performed after the processing in S9 ends, the prepared vote, to which the settlement waiting instruction information on the preceding transaction T1 is added, is transmitted to the transaction manager.

Next, the service proxy determines whether operation of the information processing device including the service proxy is stopped (S11). For example, when the operation of the information processing device including the service proxy is stopped (interrupted) due to an end of the operation of the distributed transaction control system 1, maintenance, or the like, a determination result in S11 is Yes. In contrast, when the distributed transaction control system 1 is in operation, the determination result of S11 is No.

When the service proxy determines in S11 that the operation of the information processing device including the service proxy is not stopped (determination in S11 is No), the service proxy returns the processing to S1 to repeat the processing in and after S1. In contrast, when it is determined that the operation of the information processing device including the service proxy is stopped (determination in S11 is Yes), the service proxy ends the distributed transaction control processing.

Here, returning to the description of the processing in S2 again, when the determination is No in S2 (when the received notification is the settlement notification), the service proxy determines whether the subsequent transaction T2 exists (S12). This processing is performed in which the service proxy accesses a corresponding data store (see FIGS. 1 and 2) to refer to the service execution order information (see FIG. 3), and determines whether the subsequent transaction T2 is registered for the transaction that is currently processed. When the subsequent transaction T2 is registered in the service execution order information for the transaction that is currently processed, the service proxy determines Yes as a determination result in S12, and determines No as the determination result in S12 when the subsequent transaction T2 is not registered.

When the service proxy determines in S12 that the subsequent transaction T2 exists (determination in S12 is Yes), the service proxy transmits information on settlement contents of the preceding transaction T1 (preceding settlement notification: FA6 in FIG. 1) to the transaction manager in charge of management of the subsequent transaction T2 (S13). Although not illustrated, when the contents of the received settlement notification of the transaction (preceding transaction T1), which is currently processed, is a commit (success) in the processing in S13, the service proxy changes an execution state of a corresponding transaction registered in the service execution order information (see FIG. 3) from the “in execution” to the “settled”.

Then, after the processing in S13 ends, the service proxy performs the processing in S11 described above (processing of determining whether the service proxy stops operating).

In contrast, when the service proxy determines in S12 that no subsequent transaction T2 exists (No in S12), the service proxy determines whether the contents of the settlement notification show a commit (success) (S14).

When the service proxy determines in S14 that the contents of the settlement notification show a commit (success) (Yes in S14), the service proxy changes the execution state of the corresponding transaction registered in the service execution order information (see FIG. 3) from the “in execution” to the “settled” (S15).

Next, the service proxy deletes the service execution order information (see FIG. 3) stored in the corresponding data store (See FIGS. 1 and 2) and the service control information (see FIG. 4) stored in a corresponding storage device (S16). Then, the service proxy performs the processing in S11 described above (processing of determining whether the service proxy stops operating).

In contrast, when the service proxy determines in S14 that the contents of the settlement notification do not show a commit (success) (No in S14), i.e., when the contents of the settlement notification of the subsequent transaction T2 show a rollback (failure), the service proxy sets the “locked” in the lock flag (S17). This processing obtains a lock of the compensation transaction.

Next, the service proxy sets the registration number (lock acquisition order: see FIG. 3) of the transaction having accepted (received) the settlement notification in a control parameter “i” (S18). The control parameter “i” to which the registration number is set is stored in a storage device (RAM) of an information processing device (see FIG. 2) including the service proxy.

Then, the service proxy calls a corresponding service unit, and executes the compensation transaction for the transaction of the control parameter “i” (registration number) to obtain an execution result (S19).

Next, the service proxy changes an execution state of a transaction with a registration number registered in the service execution order information (see FIG. 3), the registration number corresponding to the control parameter “i”, from the “in execution” to the “settled” (S20). Subsequently, the service proxy subtracts 1 from the control parameter “i” (registration number) and sets a result of the subtraction to the control parameter “i” (S21).

Then, the service proxy determines whether the execution state of the transaction with the registration number corresponding to the control parameter “i” is the “settled” (S22). This processing is performed in which the service proxy makes the determination with reference to the service execution order information (see FIG. 3) stored in the corresponding data store (see FIGS. 1 and 2). When the transaction with the registration number corresponding to the control parameter “i” is a target of the compensation transaction at the time of processing in S22, the execution state of the transaction is the “in execution”, and thus the determination result in S22 is No. In contrast, when the transaction with the registration number corresponding to the control parameter “i” is not the target of the compensation transaction at the time of processing in S22, the execution state of the transaction is the “settled” (e.g., see the registration number “1” in FIG. 3), and thus the determination result in S22 is Yes. Even when the transaction with the registration number corresponding to the control parameter “i” is not registered in the service execution order information (see FIG. 3) at the time of processing in S22, the determination result in S22 is Yes.

When the service proxy determines in S22 that the execution state of the transaction with the registration number corresponding to the control parameter “i” is not the “settled” (No in S22), the service proxy returns the processing to the processing in S19 and repeats the processing in and after S19. In the present embodiment, the compensation transaction according to the Saga pattern is implemented by repeating the processing in S19 to S21 until the determination result in S22 becomes Yes.

In contrast, when the service proxy determines that the execution state of the transaction with the registration number corresponding to the control parameter “i” is the “settled” in S22 (Yes in S22), the service proxy sets the “unlock” to the lock flag (S23). This processing releases the lock of the compensation transaction to end the compensation transaction according to the Saga pattern.

Next, the service proxy deletes the service execution order information (see FIG. 3) stored in the corresponding data store (See FIGS. 1 and 2) and the service control information (see FIG. 4) stored in the corresponding storage device (S24). Then, the service proxy performs the processing in S11 described above (processing of determining whether the service proxy stops operating). In the present embodiment, when the distributed transaction is executed, the distributed transaction control processing is performed by the service proxy as described above.

### (Distributed Transaction Management Processing Performed by Transaction Manager)

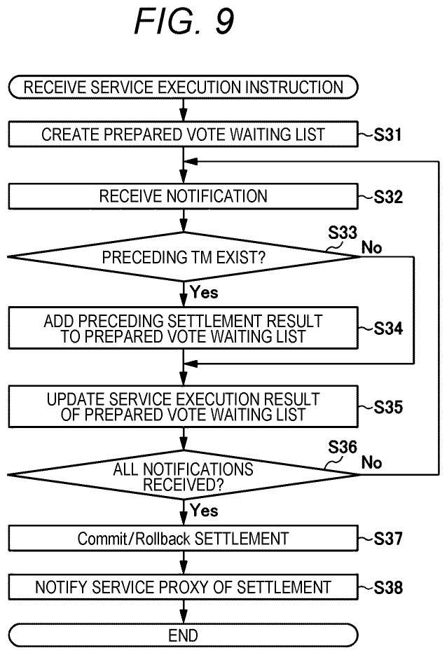

FIG. 9 is a flowchart illustrating a procedure of distributed transaction management processing performed by a transaction manager when the distributed transaction control system 1 executes the distributed transaction. The distributed transaction management processing illustrated in FIG. 9 is executed in parallel in each of the first transaction manager 11 and the second transaction manager 12. Although not illustrated, the distributed transaction management processing using the transaction manager illustrated in FIG. 9 is repeatedly executed during operation of the distributed transaction control system 1.

The distributed transaction management processing in the transaction manager illustrated in FIG. 9 is executed on software by a CPU of the information processing device (see FIG. 2) including the transaction manager. For example, the distributed transaction management processing below using the first transaction manager 11 is executed on software by the CPU 100 (see FIG. 2) of the information processing device 51 including the first transaction manager 11.

First, the transaction manager (CPU) creates an initialized prepared vote waiting list (S31). The prepared vote waiting list indicates whether a prepared vote and a preceding settlement notification have been received from each service proxy (service unit) managed by the transaction manager, and is stored in a storage device of the information processing device (see FIG. 2) including the transaction manager.

Here, a configuration of the initialized prepared vote waiting list created in processing in S31 will be specifically described with reference to FIG. 10. FIG. 10 is a diagram illustrating an example of the configuration of the initialized prepared vote waiting list created by the second transaction manager 12.

As illustrated in FIG. 10, the prepared vote waiting list includes a data set in which a transaction ID, a preceding transaction ID, a service ID, and a service execution result or a preceding settlement result, are associated with each other, the data set being set for each service proxy (service unit) managed by the transaction manager.

A column of the service execution result or the preceding settlement result is set with information corresponding to an execution result of a transaction in each service unit managed by the transaction manager. The column of the service execution result or the preceding settlement result is also set with information on a preceding settlement notification of the preceding transaction T1 when the preceding transaction T1 exists for a transaction to be processed. As the service execution result, information corresponding to “waiting for voting” is set before a prepared vote is received, and information corresponding to contents of the prepared vote (“success” or “failure”) is set after the prepared vote is received. As the preceding settlement result, information corresponding to the “waiting for voting” is set before the preceding settlement notification is received, and information corresponding to contents of the preceding settlement notification (“success” or “failure”) is set after the preceding settlement notification is received.

Then, the prepared vote waiting list created by the second transaction manager 12 and initialized in the processing in S31 is set with only information on a prepared vote registered in common regardless of whether a processing target is a preceding transaction or a subsequent transaction. Specifically, a data set (the preceding transaction ID is blank) is set in which a transaction ID, a service ID, and a service execution result (information on the prepared vote) are associated with each other for each service proxy (service unit) managed by the transaction manager.

Thus, the prepared vote waiting list created by the second transaction manager 12 and initialized, which is illustrated in FIG. 10, is set with the transaction ID that is set with its own ID “T2”, the preceding transaction ID that is set with no information, the service ID that is set with a corresponding ID (“SA”, “SB”, or “SC”), and the service execution result or the preceding settlement result that is set with the “waiting for voting” of the prepared vote (service execution result).

Here, returning to the description of the processing flow of FIG. 9 again, after the processing in S31 ends, the transaction manager performs processing of receiving notification from each service proxy (S32).

When the transaction manager is the first transaction manager 11, the notification from each service proxy is only the prepared vote (see FA3, FB3, FC3 in FIG. 1). Thus, the transaction manager performs processing in S32 in this case by performing processing of receiving the prepared vote from each service proxy. In contrast, when the transaction manager is the second transaction manager 12, the notification from each service proxy is the prepared vote and the preceding settlement notification (see FA5, FB5, FC5, FA6, FB6, FC6 in FIG. 1). Thus, the transaction manager performs the processing in S32 in this case by performing processing of receiving the prepared vote or the preceding settlement notification from each service proxy. However, at timing when no notification is received from each service proxy, the transaction manager performs standby processing in the processing in S32. That is, processing described later after S32 is performed when the transaction manager receives notification from each service proxy.

Next, the transaction manager determines whether a preceding transaction exists (S33). In this processing, the transaction manager determines whether the accepted (received) notification is a prepared vote, and whether the settlement waiting instruction information on the preceding transaction T1 is added to the prepared vote. Then, when the settlement waiting instruction information on the preceding transaction T1 is added to the received prepared vote, the transaction manager determines Yes as a determination result in S33. When the settlement waiting instruction information on the preceding transaction T1 is not added to the received prepared vote, or when the received notification is the preceding settlement notification, the transaction manager determines No as the determination result in S33.

When the transaction manager determines in the processing in S33 that no preceding transaction exists (No in S33), the transaction manager performs processing in S35 described later. In contrast, when the transaction manager determines in the processing in S33 that a preceding transaction exists (Yes in S33), the transaction manager adds information on a preceding settlement result to the prepared vote waiting list (S34).

FIG. 11 is a diagram illustrating an example of a configuration of a prepared vote waiting list to which information on a preceding settlement result is added in processing in S34. The example illustrated in FIG. 11 is also a prepared vote waiting list created by the second transaction manager 12. The example illustrated in FIG. 11 shows the prepared vote waiting list with a lowermost column set with a data set that is information on the added preceding settlement result.

The prepared vote waiting list illustrated in FIG. 11 shows the information on the added preceding settlement result in which the transaction ID is set with its own ID “T2”, the preceding transaction ID is set with “T1”, and the service ID is set with no information. During the processing in S34, the prepared vote of the subsequent transaction T2 is received before the preceding settlement notification of the preceding transaction T1 is received, so that a column of a service execution result and a preceding settlement result is set with “waiting for voting” of the preceding settlement notification. When the preceding settlement notification is received, the information in the column of a service execution result and a preceding settlement result is updated from the “waiting for voting” to contents of the preceding settlement notification (“success” or “failure”).

Here, returning to the description of the processing flow of FIG. 9 again, after the processing in S34 ends or when No is determined in S33, the transaction manager updates the information on the service execution result or the preceding settlement result in the prepared vote waiting list (S35). This processing is performed in which the transaction manager changes the information on the service execution result or the preceding settlement result corresponding to received notification (prepared vote or preceding settlement notification) in the prepared vote waiting list from the “waiting for voting” to contents of the notification (“success” or “failure”).

Next, the transaction manager determines whether all notifications have been accepted (received) (S36).

When the transaction manager determines in the processing in S36 that all the notifications have not been accepted (received) (No in S36), the transaction manager returns the processing to the processing in S32 and repeats the processing in and after S32.

In contrast, when the transaction manager determines in the processing in S36 that all the notifications have been accepted (received) (Yes in S36), the transaction manager determines a commit (success) or a rollback (failure) of the transaction (preceding transaction T1 or subsequent transaction T2) based on contents of all the notifications (S37).

Next, the transaction manager transmits the result determined in processing in S37 to each service proxy as settlement notification (S38). Then, after the processing in S38 ends, the transaction manager ends the distributed transaction management processing.

### [Various Effects]

As described above, the distributed transaction control system 1 according to the present embodiment is configured such that a service proxy having a transaction parallelism control function is provided for each service unit, and the service proxy calls the service unit to execute a plurality of transactions in parallel. At this time, a method of the lock early release is applied. Then, information (service execution order information (see FIG. 3)) on the execution order of the plurality of transactions is stored in the data store for each lock acquisition.

Then, the present embodiment enables the service proxy to transmit settlement notification waiting instruction information on the preceding transaction to the transaction manager that manages the subsequent transaction based on the service execution order information. The transaction manager that manages the subsequent transaction and has received the settlement notification waiting instruction information waits without performing settlement notification until settlement notification of the preceding transaction is received.

Thus, when the control processing described above is performed by the service proxy during parallel execution of the plurality of transactions for one resource, the plurality of transactions can be executed in the correct order even when the lock early release method is applied. That is, the present embodiment enables shortening a lock period and satisfying a requirement of serializability during the parallel execution of the plurality of transactions.

The distributed transaction control processing of the present embodiment described above enables the transaction manager, which manages the subsequent transaction, to perform the settlement notification (commit or rollback) of the subsequent transaction while the transaction manager grasps contents of the settlement notification of the preceding transaction. When the settlement result of the preceding transaction is a rollback (failure) in this configuration, the transaction manager that manages the subsequent transaction sets a settlement result of the subsequent transaction as a rollback regardless of an actual settlement result (commit or rollback) of the subsequent transaction. That is, the present embodiment enables the chain rollback to be implemented.

The present embodiment also causes the service proxy to perform the compensation transaction in execution order opposite to that when data is updated (when a transaction is executed) based on the service execution order information (see FIG. 3) when a result of the parallel execution of the plurality of transactions is a rollback (failure). Thus, the present embodiment enables a data state of the service unit to be reliably returned to a state before execution of the transaction according to the Saga pattern at the time of a rollback (failure). That is, the present embodiment enables data consistency (recoverability) at the time of a rollback (failure) to be guaranteed.

From the above, the distributed transaction control system 1 of the present embodiment enables optimal control to be executed in the distributed transaction using the Saga pattern and the lock early release.

The distributed transaction control system 1 of the present embodiment includes the transaction manager and the service proxy that are each composed of a different information processing device (separate device). This kind of configuration enables parallelism control of transactions for the service unit to be implemented by middleware (service proxy) responsibility. Thus, the present embodiment enables various combinations of service units to be flexibly addressed regardless of whether parallelism of the service units is controlled. Additionally, the transaction manager or the service unit is not required to control parallelism of transactions, so that increase in processing load in the transaction manager or the service unit can be suppressed.

### [Various Modifications]

Although the distributed transaction control system 1 according to various embodiments of the present invention has been described above, the present invention is not limited thereto, and various other modifications can be made without departing from the gist of the present invention described in the scope of claims.

The above embodiment is described with an example in which the number of transaction managers included in the distributed transaction control system 1 is two, and parallel processing (distributed transaction) is performed on the two transactions (preceding transaction T1 and subsequent transaction T2). However, the present invention is not limited thereto. For example, even when the number of transaction managers included in the distributed transaction control system 1 is three or more, and parallel processing (distributed transaction) is performed on the three or more transactions, a technique of the control of the distributed transaction described above is applicable. In this case, the technique of the control of the distributed transaction described above is applicable between two transactions (preceding transaction and subsequent transaction) adjacent to each other in execution order among the three or more transactions.

Although the above embodiment is described with an example in which the first transaction manager 11 manages the preceding transaction T1 and the second transaction manager 12 manages the subsequent transaction T2, the present invention is not limited thereto. For example, the first transaction manager 11 may manage the subsequent transaction T2, and the second transaction manager 12 may manage the preceding transaction T1.

Although the above embodiment is described with an example in which each of the plurality of service units used in the distributed transaction control system 1 has no parallelism control function, the present invention is not limited thereto. For example, the plurality of service units used in the distributed transaction control system 1 may include a service unit having the parallelism control function. In this case, the service unit having no parallelism control function is connected to the transaction manager through the service proxy having the parallelism control function as in the embodiment described above, and the service unit having the parallelism control function is directly connected to the transaction manager.

Although the above embodiment is described with an example in which the first transaction manager 11, the second transaction manager 12, and each service proxy are each composed of a different information processing device (separate device), the present invention is not limited thereto. For example, one of the first transaction manager 11 and the second transaction manager 12 may include some of the service proxies. Alternatively, one information processing device may include the first transaction manager 11 and the second transaction manager 12, for example. In this case, processing executed by each transaction manager may be executed using a common CPU or may be executed using a separate CPU.

Although the above embodiment is described with an example in which various control operation functions performed by the transaction manager and the service proxy are composed of software, the present invention is not limited thereto, and some or all of the various control operation functions may be composed of hardware.

The examples described above of the embodiment are described about detailed and specific configurations of the device to describe the present invention in an easy-to-understand manner, and the present invention is not necessarily limited to one including all the described configurations. Each drawing shows a position, a size, a shape, a range, and the like of each component that may not represent an actual position, size, shape, range, and the like to facilitate understanding of the invention. Thus, the present invention is not necessarily limited to the position, size, shape, range, and the like disclosed in each drawing and the like. Additionally, the present invention can take various other application examples and modifications without departing from the gist of the present invention described in the scope of claims.

### REFERENCE SIGNS LIST

1 distributed transaction control system
10 main service unit
11 first transaction manager
12 second transaction manager
21 first service proxy
21a, 23a, 23a data store
22 second service proxy
23 third service proxy
31 first service unit
32 second service unit
33 third service unit
51 to 53, 61 to 63, 70 to 73 information processing device
80 network

1. An information processing system comprising:
a plurality of transaction managers that manages a respective plurality of transactions to be executed in a predetermined order for an external service unit; and
a transaction controller that is connected to the plurality of transaction managers and the external service unit, and has functions of:
calling the external service unit to execute the plurality of transactions in a predetermined order;
calling the external service unit to execute a plurality of compensation transactions for the respective plurality of transactions in order opposite to the predetermined order, the plurality of compensation transactions being for returning a state of the external service unit to a state before the plurality of transactions is executed, when an execution result of the plurality of transactions is failure;
activating a lock function that disables execution of transactions other than the transaction to be processed among the plurality of transactions before calling the external service unit when executing each of the plurality of transactions; and
releasing the lock function after the transaction to be processed is executed and before an execution result of the transaction to be processed is output to a transaction manager in the plurality of transaction managers, the transaction manager serving to manage the transaction to be processed.

2. The information processing system according to claim 1, further comprising a storage unit that stores predetermined information on the predetermined order,
wherein the transaction controller controls an execution order of the plurality of transactions and an execution order of the plurality of compensation transactions based on the predetermined information stored in the storage unit.

3. The information processing system according to claim 2, wherein when an execution result of a specific transaction to be executed next to a predetermined transaction included in the plurality of transactions is output to the transaction manager that manages the specific transaction, the transaction controller adds specific information to the execution result of the specific transaction based on the predetermined information and outputs the execution result to the transaction manager that manages the specific transaction, the specific information indicating that success or failure is not determined for an execution result of the predetermined transaction.

4. The information processing system according to claim 3, wherein when the transaction manager that manages the specific transaction obtains the execution result of the specific transaction, the execution result being with the specific information added, the transaction manager waits until obtaining information on a determination result of success or failure for the execution result of the predetermined transaction from the transaction controller.

5. The information processing system according to claim 4, wherein when the transaction controller obtains a determination result of success or failure for the execution result of the predetermined transaction from the transaction manager that manages the predetermined transaction, after outputting the execution result of the predetermined transaction to the transaction manager, the transaction controller outputs information on the determination result to the transaction manager that manages the specific transaction.

6. The information processing system according to claim 5, wherein when the transaction manager that manages the specific transaction obtains a determination result of failure for the execution result of the predetermined transaction from the transaction controller, the transaction manager determines a determination result of failure for the execution result of the specific transaction and outputs the determination result of failure to the transaction controller.

7. The information processing system according to claim 2, wherein the transaction controller does not clear the predetermined information stored in the storage unit even when the transaction controller stops operating during execution of the plurality of transactions and/or during execution of the plurality of compensation transactions.

8. The information processing system according to claim 1, wherein the transaction controller is provided separately from the plurality of transaction managers, and is connected to the plurality of transaction managers and the external service unit through an external network.

9. An information processing device comprising:
a transaction controller that is connected to a service unit provided outside and a plurality of transaction managers provided outside to manage a respective plurality of transactions to be executed in a predetermined order for the service unit,
the transaction controller having functions of:
calling the service unit to execute the plurality of transactions in the predetermined order;
calling the service unit to execute a plurality of compensation transactions for the respective plurality of transactions in order opposite to the predetermined order, the plurality of compensation transactions being for returning a state of the service unit to a state before the plurality of transactions is executed, when an execution result of the plurality of transactions is failure;
activating a lock function that disables execution of transactions other than the transaction to be processed among the plurality of transactions before calling the service unit when executing each of the plurality of transactions; and
releasing the lock function after the transaction to be processed is executed and before an execution result of the transaction to be processed is output to a transaction manager in the plurality of transaction managers, the transaction manager serving to manage the transaction to be processed.

10. An information processing method performed by an information processing device including a transaction controller that is connected to a service unit provided outside and a plurality of transaction managers provided outside to manage a respective plurality of transactions to be executed in a predetermined order for the service unit,
the method comprising the steps of:
calling the service unit using the transaction controller to execute the plurality of transactions in the predetermined order;
calling the service unit using the transaction controller to execute a plurality of compensation transactions for the respective plurality of transactions in order opposite to the predetermined order, the plurality of compensation transactions being for returning a state of the service unit to a state before the plurality of transactions is executed, when an execution result of the plurality of transactions is failure;
activating a lock function using the transaction controller, the lock function disabling execution of transactions other than the transaction to be processed among the plurality of transactions before calling the service unit when executing each of the plurality of transactions; and
releasing the lock function using the transaction controller after the transaction to be processed is executed and before an execution result of the transaction to be processed is output to a transaction manager in the plurality of transaction managers, the transaction manager serving to manage the transaction to be processed.
